(19) United States
(12) Patent Application Publication
(10) Pub. No.: US 2002/0114564 A1
(43) Pub. Date: Aug. 22, 2002

(54) Variable angle light rod and light reflecting prism rod

(75) Inventor: Keith F. Tracy, Winsted, CT (US)

Correspondence Address: Michael H. Wallach, Litton Systems, Inc., Suite 302, 147 Columbia Turnpike, Florham Park, NJ, 07932, US

(73) Assignee: Litton Systems, Inc.

(21) Appl. No.: 09/785,507

(22) Filed: Feb. 20, 2001

(51) Int. Cl. G02B 6/26

(52) U.S. Cl. 385/32; 385/15; 385/47

(57) ABSTRACT

A method and apparatus for shaping and redirecting a light beam in a light guiding media is described. The angle at which the light guiding media redirects the light beam is a variable predetermined value. A light beam is received at a first end of a light guiding media and redirected at an angle in relation to the angle at which the light beam is received. The light beam is transmitted through a second end of the light guiding media. The apparatus includes a light guiding media having an angular bend with an inner portion and an outer bend portion. The outer bend portion of the angular bend has a flat surface of the light guiding media having internal reflective properties. Another method and apparatus for spreading a light beam at a variable angle at a location is described in which a light guiding media is formed to shape and redirect a light beam. A first cut is formed at an angle to the axial direction of the light guiding media and a second cut is along an axial length of the light guiding media in relation to the first cut.

### FIELD OF THE INVENTION

The present invention relates to a method of and apparatus for shaping and redirecting a light beam in a light guiding media, and more particularly, to such a method and apparatus wherein the light guiding media redirects the light beam at a variable fixed angle. Still more particularly, the present invention includes a method and apparatus for spreading the light beam at a variable fixed angle.

### BACKGROUND OF THE INVENTION

There are many, varied applications for shaping and redirecting a light beam in a light guiding media, e.g., remote source lighting, imaging and inspection capabilities, providing light in constrained spaces. One such application involves the use of redirected and shaped light beams provided to the deckwash of a ship or sea platform. In such applications, it is desirable to use a light guiding media to provide light to a location due to the inherent ruggedness of the illuminating mechanism. The light beam may be redirected from a remote light source located below deck via the light guiding media and directed to provide light to the deck.

There are at least two difficult aspects of providing a light beam in the above-described application: shaping and spreading the light beam at the intended location and directing the light beam through and to a narrow constrained location. The light provided at a particular location needs to be shaped in order to provide the necessary amount of light and coverage area. The cable raceways typically available do not provide for a large radius turn of a light rod. Thus, an optical coupler or other mechanism is needed to redirect light to the intended location. Previous approaches to addressing these issues are discussed below.

Typically, the shaping and redirection of a light beam is accomplished using prisms, mirrors, and/or lenses. Previous approaches to redirecting light have used two light rods in conjunction with a prism, for example, the connection device of U.S. Pat. No. 5,305,401 to Becker et al. The light rods are placed perpendicular to one another and end-to-end with the prism oriented at the juncture such that light exiting one of the light rods is reflected to the entrance of the other light rod. Multiple components must be precisely aligned in order to obtain a desired result. Such precision alignment requires additional time and expense for setup and maintenance. Even if the components are properly aligned, there are light losses as a result of the light beam crossing several media interfaces; namely, light rod to air, air to prism, prism to air, and air to light rod. Thus, there is a need in the art for a mechanism to shape and redirect a light beam while minimizing the amount of transmission loss.

Another approach, such as in U.S. Pat. No. 5,604,837 to Tanaka and U.S. Pat. No. 5,774,608 to Allen et al., uses a single bent rod or glass fiber bundle to redirect the light beam. A difficulty encountered with this approach is an inability to bend the rod or bundle to a sharp radius without incurring large light transmission losses. In the ship-based application, space is very valuable and minimizing the space used is important. Further, an image obtained through the use of a bent rod is typically fuzzy. It would be useful in imaging and inspection applications to be able to obtain a sharp usable image from a bent light rod. Thus, there is a need in the art to enable a sharp bend in a light rod to minimize the space required to redirect a light beam. Further, there is a need in the art to obtain a sharp, usable image from a bent light rod.

Through the use of the “light reflecting prism rod” a single device replaces multiple components and still performs a similar function for many applications. The light reflecting prism rod reduces assembly and setup time and provides higher efficiencies of light transmission due to fewer surfaces for the light to encounter. Thus, there is a need in the art for a simplified light shaping and distributing luminaire.

### SUMMARY OF THE INVENTION

Accordingly, an object of the present invention is to shape and redirect a light beam while minimizing the transmission losses.

Another object of the present invention is to enable a sharp bend in a light rod to minimize the space required to redirect a light beam.

Another object of the present invention is to obtain a sharp, usable image from a bent light rod.

Another object of the present invention is to provide a simplified light shaping and distributing luminaire.

The present invention relates generally to a method of and apparatus for shaping and redirecting a light beam in a light guiding media, and more particularly, to such a method and apparatus wherein the light guiding media redirects the light beam at a variable angle. Still more particularly, the present invention includes a method and apparatus for spreading the light beam at a variable angle.

A method aspect of the present invention receives a light beam at a first end of a light guiding media and redirects the light beam at an angle in relation to the angle the light beam is received. The light beam is then transmitted through a second end of the light guiding media.

An apparatus aspect for shaping and redirecting a light beam in a light guiding media includes a light guiding media having an angular bend with an inner bend portion and an outer bend portion. The outer bend portion of the angular bend has a flat surface of the light guiding media having internal reflective properties.

Another method aspect relates to manufacturing a light guiding media for shaping and redirecting a light beam. A light guiding media is bent at at least one location along the length of the light guiding media such that the bend of the light guiding media has an inner bend portion and an outer bend portion. A flat surface is produced at the outer bend portion of the light guiding media wherein the flat surface provides internal reflective properties to the face internal to the light guiding media.

Another apparatus aspect for shaping and redirecting a light beam includes a light guiding media having a plurality of cuts at one end for shaping and redirecting a light beam. A first cut is at an angle to the axial direction of the light guiding media and a second cut is along an axial length of the light guiding media in relation to the first cut.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a side view of a bent light rod;

FIG. 1A is a side view of another embodiment of the bent light rod;

FIG. 2 is an end view of the bent light rod of FIG. 1;

FIG. 3 is a top view of a light reflecting prism rod according to the present invention;

FIG. 4 is a side view of the light reflecting prism rod of FIG. 3;

FIG. 5 is a top view of another embodiment of a light reflecting prism rod according to the present invention; and

FIG. 6 is a side view of the light reflecting prism rod of FIG. 5.

### DETAILED DESCRIPTION OF THE DRAWINGS

With respect to the following descriptions, a light guiding media may be an optical rod, solid fiber, or bundled fibers of glass, acrylic, or an optically clear plastic used to transmit light.

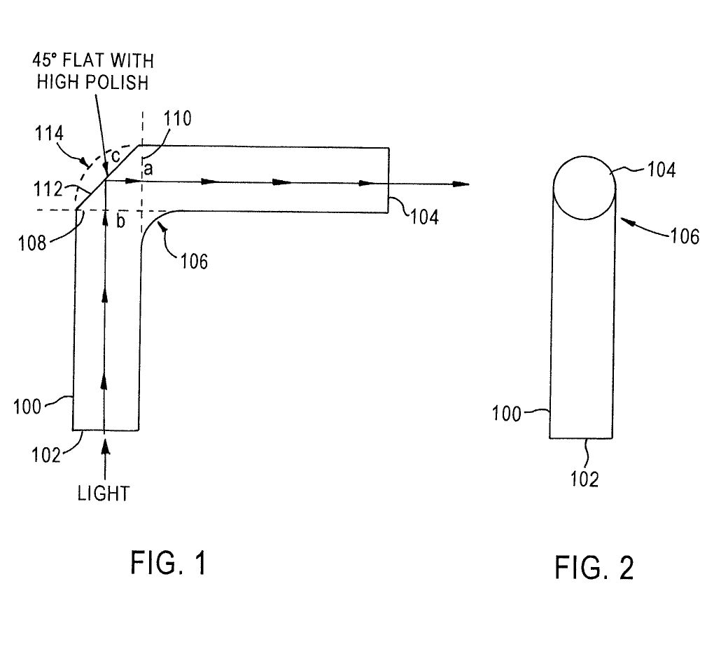

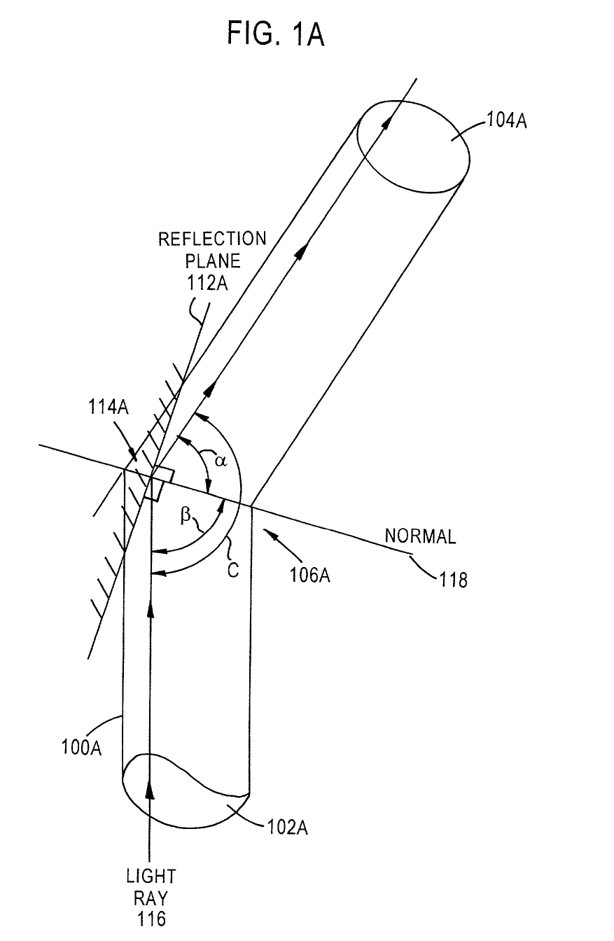

Turning now to FIG. 1, a light rod 100 bent at a ninety degree angle is shown. Though a ninety degree angle is shown and described, other angles may be used in differing embodiments. Experimentation has shown that an angle of about 120 degrees is the maximum bend angle experiencing little or no losses due to internal reflection. A light beam enters light rod 100 at one end 102 and exits light rod 100 at another end 104. The light rod bend, generally indicated by reference numeral 106, and more specifically, a flat surface 112 of the light rod bend, is where the light beam is redirected from entrance end 102 to exit end 104.

Reference numeral 108 indicates the diameter of the light rod 100 along the entrance end 102 and reference numeral 110 indicates the diameter of the light rod 100 along the exit end 104. Flat surface 112 is located at the outside portion of the light rod bend 106. Reference numeral 114 indicates the portion of light rod 100 removed (dashed line) for flat surface 112 placement.

Flat surface 112 is a flat, highly polished, internally, reflective surface. The light beam entering entrance end 102 proceeds along the light rod 100 to flat surface 112. The light beam reflects off flat surface 112 and exits exit end 104. The use of flat surface 112 greatly reduces the amount of internal reflection losses in comparison to a bent light rod wherein the removed portion 114 is not removed and a flat, reflective surface is not used at bend 106.

In the ninety degree bend example of FIG. 1, flat surface 112 intersects light rod 100 as a circular region at bend 106 when viewed axially along the light beam transmission. Flat surface 112 intersects light rod 100 at bend 106 and extends across the plane of the entrance end 102. The length (diameter, in this example) of the flat surface 112 is variable, depending on the angle of bend 106 and, in some applications, the location of the light beam within light rod 100.

FIG. 1A is a side view of another embodiment of the present invention having a different reflection angle than the embodiment of FIG. 1. FIG. 1A includes a light rod 100A having an entrance end 102A and an exit end 104A and a bend 106A location where a light ray 116 entering the entrance end is reflected and redirected to the exit end. The embodiment of FIG. 1A is the same as light rod 100 except that a light ray 116 enters the entrance end 102A having a smaller cross-section, or smaller diameter than the light entering entrance end 102. Further, the light ray 116 is reflected at a greater angle at bend 106A than the ninety degree reflection angle at bend 106 and flat surface 112 is of a different size than the flat surface 112A.

With respect to FIG. 1A, normal plane 118 represents an angle bisecting the angle formed by the reflection of light ray 116 at flat surface 112A. Specifically, α is the angle formed by the light ray 116 exiting exit end 104A and normal plane 118 and β is the angle formed by the light ray entering entrance end 102A and normal plane 118. The sum of α and β is the angle C, the angle of the reflection of light ray 116 at flat surface 112A. Flat surface 112A is a flat surface perpendicular to normal plane 118, i.e., flat surface 112A is at a right angle to normal plane 118.

If a light beam smaller than the diameter of light rod 100A is used, then the length of flat surface 112A may be reduced to be sufficient to reflect the needed portion of the light beam.

FIG. 2 is an end view diagram of the light rod 100 of FIG. 1. Light rod 100, in this view, is oriented such that a light beam entering entrance end 102 will cross the light rod bend 106 and exit the exit end 104 such that a light beam would come out of the paper.

The light rod 100 with integral bend 106 may be formed as part of a longer light distribution apparatus or the light rod 100 may be used as an optical coupler connecting additional light rods and/or lighting fixtures. Advantageously, the light rod 100 with integral bend 106 is able to turn sharp radius corners with minimal light losses beyond the critical angle in comparison to traditional light bending rods. Depending on specific application requirements and amount of acceptable light loss, the light rod 100 with bend 106 has been demonstrated to adequately perform at angles up to one hundred twenty degrees.

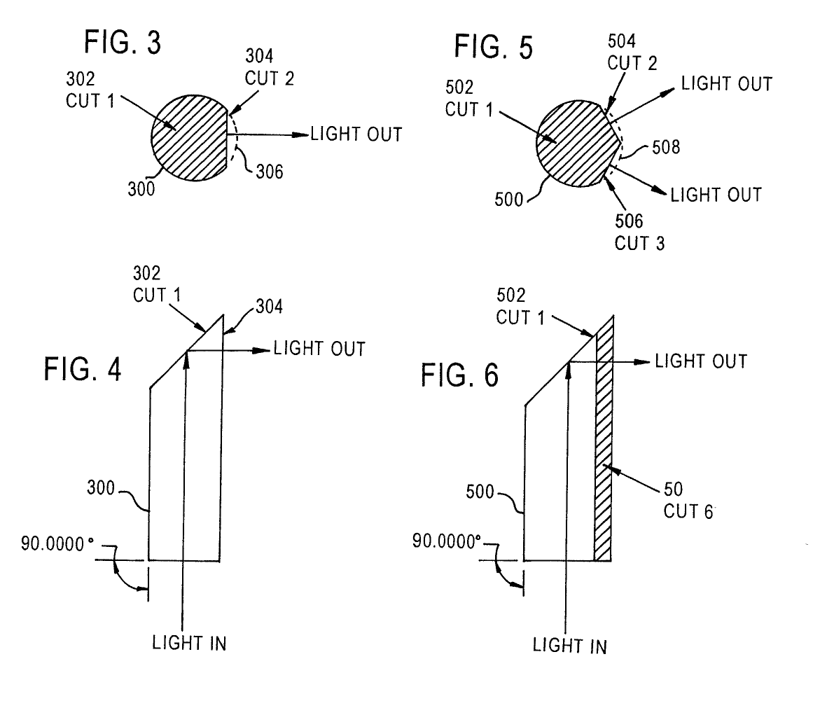

A top view of another light rod embodiment employing a flat, high polish, reflective surface is shown in FIG. 3. FIG. 3 is a top axial length view of light prism rod 300, shown in a longitudinal or side view in FIG. 4. A first cut of light prism rod 300 is indicated by reference numeral 302. First cut 302 is similar to the flat, high polish, reflective surface 112 of the FIG. 1 embodiment. A second cut of light prism rod 300 is indicated by reference numeral 304 and begins at the distal end of first cut 302, as shown in FIG. 4. The removed portion of light prism rod 300 removed by second cut 304 is indicated by reference numeral 306 (dashed line). A light beam entering light prism rod 300 proceeds to first cut 302 and is reflected toward and through the face of light prism rod 300 formed by second cut 304.

The angle of first cut 302 in conjunction with the length of second cut 304 determines the height of the light provided by light prism rod 300 as viewed in FIG. 4. The width of second cut 304 determines the width or spread of the light provided by light prism rod 300 as viewed from the perspective of FIG. 3. In this manner, light from a remote location may be provided to a location with minimal available space and may be configured to cover a determined height and width of an area. By increasing the size of second cut 304, e.g., increasing the depth of cut 304, the resulting light beam will spread over a wider area.

A top view of another light prism rod embodiment similar to light prism rod 300 is shown in FIG. 5. FIG. 5 is a top axial length view of light prism rod 500, shown in a longitudinal or side view in FIG. 6. A first cut of light prism rod 500 is indicated by reference numeral 502. First cut 502 is the same as first cut 302 of FIG. 3 and as such is a flat, high polish, reflective surface. A second and third cut of light prism rod 500 is indicated by reference numerals 504 and 506, respectively, and begin at the distal end of first cut 502, as shown in FIG. 6. The second and third cuts 504 and 506 abut along the axial length of light guiding media 500. The removed portion of light prism rod 500 removed by the second and third cuts 504 and 506 is indicated by reference numeral 508 (dashed line). A light beam entering light prism rod 500 proceeds to first cut 502 and is reflected toward and through the face of light prism rod 500 formed by second and third cuts 504 and 506.

Similarly to the embodiment of FIGS. 3 and 4, the angle of first cut 502 in conjunction with the length (longitudinal length along light prism rod 500) of second and third cuts 504 and 506 determines the height of the light beam provided by light prism rod 500 as viewed in FIG. 6. The width of second and third cuts 504 and 506 determines the width or spread of the light provided by light prism rod 500 as viewed from the perspective of FIG. 5. In this manner, light from a remote location is provided to a location with minimal available space and is configured to cover a determined height and width of an area. An increase in the size of the axial portion of second and/or third cut 504 and 506 of light prism rod 500 results in the light beam spreading over a wider area.

The second and third cuts 504 and 506 may be sized independently from one another. Advantageously, two different areas may be illuminated using the same light prism rod. Further, the length and width of the cuts may be varied enabling the illumination of different sized areas. Additionally, if the light prism rod is molded or formed using a mold-type process, the cuts (502-506) need only be as wide as the reflected beam.

In both embodiments shown in FIGS. 3-6, the resulting light prism rod can be used as a standalone luminaire, i.e., light shaping and delivery device, with fewer parts than conventional luminaires and producible at a lower cost.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of shaping and redirecting a light beam in a light guiding media having a bend of a specific angle, comprising the steps of:
receiving a light beam at a first end of a light guiding media;
redirecting the light beam within the light guiding media at an angle in relation to the angle the light beam is received; and
transmitting the light beam through a second end of the light guiding media.

2. The method as claimed in claim 1, wherein the light beam is redirected with a flat surface of the light guiding media at the bend.

3. The method as claimed in claim 2, wherein the flat surface redirecting the light beam is a high polish, reflective surface.

4. The method as claimed in claim 1, wherein the specific angle of the bend is in a range from about zero to about 120 degrees.

5. An apparatus for shaping and redirecting a light beam in a light guiding media, comprising:
a light guiding media having an angular bend with an inner bend portion and an outer bend portion,
wherein the outer bend portion of the angular bend has a flat surface of the light guiding media having internal reflective properties.

6. The apparatus as claimed in claim 5, wherein the flat surface is a high polish, reflective surface.

7. The apparatus as claimed in claim 5, wherein the angular bend is in a range from about zero to about 120 degrees.

8. A method of manufacturing a light guiding media for shaping and redirecting a light beam in the light guiding media, comprising the steps of:
bending the light guiding media at at least one location along the length of the light guiding media such that the bend of the light guiding media has an inner bend portion and an outer bend portion; and
producing a flat surface at the outer bend portion of the light guiding media wherein the flat surface provides internal reflective properties to the face internal to the light guiding media.

9. The method as claimed in claim 8, wherein the flat surface is a high polish, reflective surface.

10. The method as claimed in claim 8, wherein the angle of the bend is in a range from about zero to about 120 degrees.

11. An apparatus for shaping and redirecting a light beam, comprising:
a light guiding media having a plurality of cuts at one end for shaping and redirecting a light beam:
wherein a first cut of said plurality of cuts is at an angle to the axial direction of said light guiding media and a second cut is along an axial length of said light guiding media in relation to said first cut.

12. The apparatus as claimed in claim 11, wherein the first cut is a flat, high polish, reflective surface.

13. The apparatus as claimed in claim 11, wherein the angle of the first cut is in a range from about zero to about 120 degrees.

14. The apparatus as claimed in claim 11, further comprising a third cut along an axial length of said light guiding media in relation to said first cut parallel to said second cut.

15. The apparatus as claimed in claim 14, wherein the first cut is a flat, high polish reflective surface.

16. The apparatus as claimed in claim 14, wherein the angle of the first cut is in a range from about zero to about 120 degrees.

17. The apparatus as claimed in claim 14, wherein the second and third cuts adjoin each other along the axial length of the light guiding media.

18. The apparatus as claimed in claim 14, wherein the second and third cuts are of the same size.

19. The apparatus as claimed in claim 14, wherein the second and third cuts are in a specific ratio to each other.
